(19) United States
(12) Patent Application Publication
(10) Pub. No.: US 2003/0129899 A1
(43) Pub. Date: Jul. 10, 2003

(54) FIBER REINFORCED ROOFING MAT

(76) Inventor: JOHN R. FIELDS, SUMNER, WA (US)

Correspondence Address: BROWN, RAYSMAN, MILLSTEIN, FELDER & STEINER LLP, 900 THIRD AVENUE, NEW YORK, NY, 10022, US

(21) Appl. No.: 09/340,714

(22) Filed: Jun. 29, 1999

Related U.S. Application Data
(60) Provisional application No. 60/091,125, filed on Jun. 29, 1998.

(51) Int. Cl. B32B 5/16; D04H 3/00; B32B 27/04; D21H 13/10; D21H 19/00; D21H 13/40; D21H 27/22; B32B 5/02

(52) U.S. Cl. 442/85; 428/292.7; 442/417; 442/415; 442/413; 162/202; 162/205; 162/135; 162/156; 162/157.1; 427/391; 427/361

(57) ABSTRACT

Method and apparatus for fiber-reinforced mats and asphalt coated sheets for use in roofing and water resistant membranes. Mats and sheets according to the invention exhibit superior tensile strength and resistance to wrinkling. The mat aspect of the invention comprises product and method for producing mats comprised of organic matting materials such as cellulose, paper, other wood products, or felt, and reinforcing fibers such as fiberglass, plastics, and other relatively high-strength natural and synthetic fibers, the fibers being incorporated within the matting material during production of the mat. The sheet aspect of the invention comprises product and method for mats of the type described above with added asphalt coatings to improve the water-proofing qualities of the mats.

This application claims the benefit of U.S. provisional patent application serial No. 60/091,125, filed Jun. 29, 1998, and entitled Fiber Reinforced Roofing Mat.

### TECHNICAL FIELD

The invention relates to roofing, waterproofing, and water resistant products; more particularly, it relates fiber-reinforced roofing and waterproofing mats exhibiting superior tensile strength and wrinkle resistance, and to sheets made by coating such mats with asphalt.

### BACKGROUND OF THE INVENTION

The construction of roofing, waterproofing, and water resistant membranes through the use of water-resistant and asphalt-coated sheets and mats has long been known. For example, for many years felt sheets have been nailed into place on roofs, etc., and coated, once in place, with waterproofing or water-resistant material such as asphalt or other bitumens.

Felt is one of the longest-used mat and sheet materials for making asphalt-coated water resistant membranes. Historically, felt has comprised nonwoven, matted fabrics made of wool, fur, hair, and similar organic materials matted together by use of heat, moisture, and pressure. More recently matted cellulose, paper, and similar organic materials have been used. Collectively, mats made from these materials have been referred to in the roofing and waterproofing industry as “organic felts”, in order to distinguish them from sheets made of polyester, fiberglass, and other natural and synthetic, generally inorganic materials. Organic felts have served admirably, as they are relatively inexpensive and easy to work with, and because they have a greater tendency to absorb (and therefore be saturated by) asphalt when coated, and thus provide membranes which are relatively impervious to moisture. Inorganic mats are also known. For example, U.S. Pat. Nos. 4,681,802 and 4,592,956 to Gaa et al.; U.S. Pat. Nos. 4,626,289 and 4,536,447 to Hsu; U.S. Pat. No. 4,405,680 to Hansen; U.S. Pat. Nos. 4,242,404 and 4,233,353 to Bondoc et al.; U.S. Pat. Nos. 4,129,674 and 4,112,174 to Hannes et al.; and U.S. Pat. No. 4,118,272 to Ziegler et al. all describe methods and compositions for roofing mats composed chiefly of inorganic glass fibers. As suggested previously, however, inorganic mats, and in particular glass fiber mats, are relatively resistant to the absorption of asphalt and other roofing membrane compositions.

Mats composed solely of organic materials have shortcomings as well. These shortcomings include, especially when the mats are coated with asphalt and used in roofing or waterproofing membranes, the relatively low tensile strengths of the felts and their susceptibility to wrinkling—particularly when coated with hot asphalt and the like. The susceptibility of felts to both tearing and wrinkling makes them more difficult to use, and—this is especially true due to the relatively low tensile strength of the materials—can decrease the useful or effective lives of water resistant membranes in which they are incorporated. Water resistant membranes such as roofs are very commonly exposed to extreme temperatures and to hot, bright sunlight. Under such circumstances, and particularly when they have been coated with asphalts or other typically dark or black bituminous materials, the membranes absorb a great amount of heat, and as is typical for heated materials, tend to expand. Conversely, when the sunlight or heat is removed and the membranes are allowed to cool, they tend to contract. Such heat-induced expansion and contraction cycles, which are sometimes referred to as thermal shock cycles, can cause the materials of which the membranes are made to break down, due to fatigue. This is especially true when, as is generally the case in roofing membranes, the cycle is repeated on a daily or even, as is often the case, a semi-daily basis. And when the membrane-coating material (as for example asphalt) has itself been previously degraded by exposure to sunlight, ultraviolet (UV) rays, ozone, and other environmental factors, or when the membrane is composed of materials having relatively low tensile strengths, the fatigue failure and ultimate inability of the membrane to serve its water resistant purpose are still further accelerated.

It is also known that water resistant membranes serve their purpose best when they allow water to run off of the membrane instead of standing or pooling in place. Pooling or standing of water tends to accelerate the failure of water resistant membranes in a variety of ways, including by facilitation of the introduction of mosses, fungus, and other biological agents, which attack the membrane materials, and by increasing the likelihood of water being present when other failures begin. For example, pooling of water on a roof the waterproof integrity of which has already been compromised through thermal shock failure permits water to be on hand for extended periods, and therefore to seep or otherwise drain through developing or completed cracks. This can lead to further damage to the roof or other substrate, and to discomfort and unhealthy conditions for occupants of the formerly protected structure. It is clear that opportunities for pooling or standing of water are increased on water resistant membranes which are not sufficiently flat. For example, if a membrane is comprised of wrinkled sheet material, small (or large) pools of water can be allowed to accumulate after rainstorms.

Wrinkled sheets can also be difficult to work with and install. Wrinkling commonly occurs either when a felt is coated with hot asphalt in a coating line, when it is placed on a roll, or when it is not handled carefully enough during the installation process. When the sheets wrinkle, especially during the coating or installation processes, much economic loss may be suffered due to the production of substandard or unusable product or the need for replacing installed membranes. Unfortunately, organic felts traditionally used in the roofing and water resistant industries have been known to exhibit annoyingly high tendencies to wrinkle. Some progress has been made in efforts to control wrinkling in sheets during the coating process in the case of natural and synthetic sheet materials which are highly prone to transverse shrinking, or “necking,” when heated. See, for example, my patent application Ser. No. 09/035,437, entitled Asphalt Coated Mat and filed Mar. 5, 1998. The specification for that application is hereby incorporated in this specification as if set forth in full. Yet there remains a need for wrinkle-resistant sheets which may be coated without special line apparatus, and the problems and expenses associated therewith.

Thus there is a need for a roofing or water resistant mat, and for coated sheets made using such mats, having improved tensile strengths and improved resistance to wrinkling, particularly when heated or when brought into contact with hot asphalt or other coatings or saturants, having good absorption characteristics for asphalts and other roofing materials. There is also a need for roofing and water resistant membrane materials having increased resistance to thermal shock cycles, and to breakdown due to exposure to sunlight, ultraviolet (UV) rays, ozone, and other environmental factors. There is still a further need for such mats and sheets which minimize standing or pooling of water on protected structures following installation.

### DISCLOSURE OF THE INVENTION

Accordingly, it is an object of the invention to provide a roofing or water resistant mat, and coated sheets made using such mats, having improved tensile strengths and improved resistance to wrinkling, particularly when heated or when brought into contact with hot asphalt or other coatings or saturants, and providing good absorbency for asphalts and other roofing compositions. It is also an object of the invention to provide roofing and water resistant membrane materials having increased resistance to thermal shock cycles, and to breakdown due to exposure to sunlight, ultraviolet (UV) rays, ozone, and other environmental factors. It is still another object of the invention to provide roofing and water resistant mats and sheets which minimize standing or pooling of water on protected structures following installation. It is yet another object of the invention to provide mats and sheets of the type described herein which may be made and may be coated with asphalts or other saturants on conventional mat-making and roofing line apparatus, without need for extensive modifications.

These and such other objects of the invention as will become evident from the disclosure below are met by the invention disclosed herein. The invention provides method and apparatus for roofing mats composed chiefly of organic materials, but reinforced with inorganic or other relatively stiff, high-strength materials, mainly in the form of inorganic fiber-reinforced organic mats and asphalt coated sheets for use in roofing and water resistant membranes. Mats and sheets according to the invention exhibit superior tensile strength, dimensional stability, and resistance to wrinkling. The mat aspect of the invention comprises product and method for producing mats comprised of organic base matting materials including cellulose, paper, other wood products, felt, and other organic matting materials, and reinforcing fibers such as fiberglass, plastics, and other relatively high-strength natural and synthetic fibers, the fibers being dispersed or incorporated within the matting material during production of the mat. The sheet aspect of the invention comprises product and method for mats of the type described above with added asphalt coatings to improve the water-proofing qualities of the mats.

In one aspect the invention provides a mat for use in water resistant membranes. The mat is comprised of a matting material selected from the group comprising cellulose, paper, other wood products, felt, and other organic matting materials, together with reinforcing fibers such as fiberglass, plastics, and other relatively high-strength natural and synthetic fibers, the fibers dispersed or incorporated within the matting material during production of the mat. Generally preferred mats according to this aspect of the invention comprise between about 1% and about 20%, and most preferably between about 5% and about 10%, by weight of reinforcing fibers, and have widths of between about 24 inches and about 240 inches to accommodate their use in standard roofing and water resistant projects. They have thicknesses of preferably between about 15 mils and about 50 mils, and weights of between about 0.02 pounds per square foot and about 0.10 pounds per square foot.

Mats according to this aspect of the invention are preferably produced by a method comprising the steps of preparing a more or less substantially uniform pulp of material selected from the group comprising cellulose, paper, other wood products, felt, and other organic matting materials, reinforcing fibers selected from the group comprising fiberglass, plastics, and other relatively high-strength natural and synthetic fibers, and water, the combination comprising at least about 1% by dry weight of reinforcing fibers; introducing the pulp to a mold, which typically and most preferably takes the form of a meshed screen; and drying the pulp. It is generally preferred in making the mats to subject the molded pulp to heat and or pressure, and various combinations of heat and pressure, to assist in drying the pulp. It is also generally preferred in making such mats to wind the dried mat into rolls when the mat is finished, in order to accommodate their use and installation in roofing and waterproofing projects.

In another aspect the invention provides asphalt coated fiber reinforced sheets for use in water resistant membranes. A sheet according to this aspect of the invention comprises a mat having two sides and comprised of a matting material selected from the group comprising cellulose, paper, other wood products, felt, and other organic materials, and reinforced with fibers selected from the group comprising fiberglass, plastics, and other relatively high-strength natural and synthetic fibers, the fibers incorporated in the sheet during production of the sheet; and an asphalt coating applied to at least one of the sides of the mat. Preferred sheets according to this aspect of the invention comprise between about 1% and about 20% by weight reinforcing fibers before application of the asphalt, and have widths between about 24 inches and about 240 inches to accommodate their use in standard roofing and water resistant processes. They further have thicknesses of between about 15 mils and about 60 mils after application of the asphalt, and weight between about 0.06 pounds per square foot and about 0.30 pounds per square foot after application of the asphalt.

Sheets according to this aspect of the invention are preferably produced by a method comprising the steps of placing a mat on a feed roll, the mat having two sides and a free end and comprised of a matting material selected from the group comprising cellulose, paper, other wood products felt, and other organic matting materials, and reinforcing fibers selected from the group comprising fiberglass, plastics, and other relatively high-strength natural and synthetic fibers, the fibers incorporated within the matting material; placing the free end of the mat between nips of a feed mechanism; passing the sheet through a coating section disposed between said feed mechanism and said feed roll; and coating at least one of the sides of the mat with asphalt as it passes through the coating section.

It is generally preferred that reinforcing fibers be mixed with organic pulp materials during formation of mats according to the invention such that a substantially random distribution or incorporation of fibers within the finished mat results. Such a distribution allows the reinforcing fibers to have excellent effect in reinforcing the organic matting material, at least in part due to the random orientation of the fibers within the finished, dry mat.

### BRIEF DESCRIPTION OF THE DRAWINGS

FIG. 1 is a schematic perspective view of a preferred embodiment of a mat according to the invention.

FIG. 2 is a schematic view of a preferred embodiment of a process for making a mat according to the invention.

FIG. 3 is a sectional schematic view of a preferred embodiment of an asphalt coated fiber reinforced sheet according to the invention.

FIG. 4 is a schematic view of a preferred embodiment of a process for making an asphalt coated fiber reinforced sheet according to the invention.

### BEST MODE OF CARRYING OUT THE INVENTION

For purposes of this disclosure, asphalt means any bituminous material or hydrocarbon, with or without additives, fillers, or aggregates, having sufficient insolubility in water and viscosity to be used advantageously in roofing, sealing, paving, or water resistant, whether naturally occurring or distilled from petroleum or like products. In particular asphalt includes, without limitation, straight-run asphalts or asphalts modified by the addition of rubbers or other polymers, coal, tar, and pitch, as well as all bitumens and modified bituminous materials, whether oxidized or unoxidized. For accomplishing the purposes disclosed herein bitumens such as asphalt having a softening point of between about 10° C. and about 107° C. (50° F. and about 225° F.) with penetration at 77 degrees F. of about 12 to about 100 1/10 millimeters may be used to advantage as is, or may be modified by the addition of rubber or other polymers, as for example styrene ethylene butylene styrene copolymer (SEBS), atactic polypropylene (APP), and styrene-butadiene-styrene (SBS). One formulation of SEBS copolymer used with great advantage in this invention is obtained from Imperbel America Corporation of 717 South 38th, P.O. Box 6761, Kansas City, Kans., 66106, having a product designation of I 175.

Organic matting material means any material of an organic origin suitable for use in mats of the type suitable for use for the purposes described herein. Examples of organic matting materials include cellulose, whether derived from wood, plants, or other sources, paper, other wood products, and any type of felt or felt material.

Reinforcing fibers suitable for use with the invention are any fibers of suitable size, shape, strength, and durability for the purposes contemplated herein. Such fibers are typically, but not necessarily exclusively, inorganic in type. Suitable materials include fiberglass, plastics, and other polymers and synthetic fibers.

Turning now to the drawings, the invention will be described in a preferred embodiment by reference to the numerals of the drawing figures wherein like numbers indicate like parts.

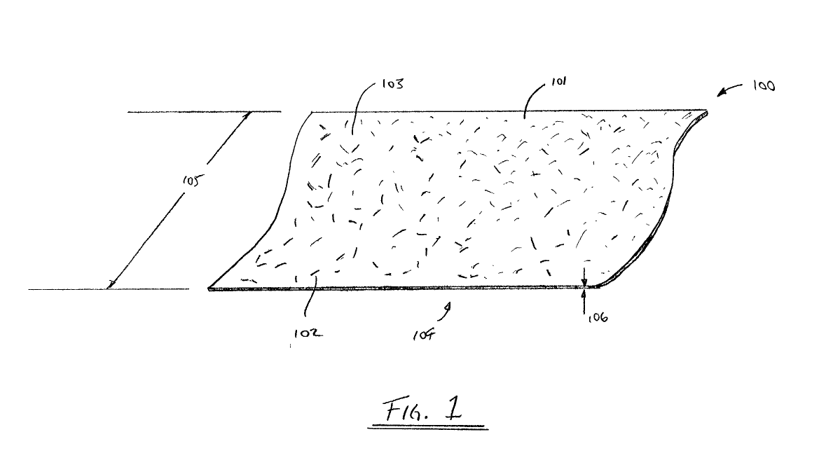

FIG. 1 is a schematic perspective view of a preferred embodiment of a mat according to the invention. Mat 100 has first side 103, second side 104, width 105, and thickness 106. The mat is comprised of matting material 101 and reinforcing fibers 102.

Matting material 101 may comprise cellulose, paper, other wood products, felt, and/or any other organic matting material, singularly or in combination. Paper is a particularly preferred matting material, and may be employed in either new or in recycled form. Superior and extremely cost-effective results have been achieved in producing mats according to this aspect of the invention using a mixture of about one part virgin paper stock and about two parts recycled paper (for example, approximately 35% virgin paper and approximately 65% recycled), although a wide range of mixtures has proved suitable. In addition to paper, wood products, cotton, felts, hairs, cellulose, and a wide variety of other materials serve very well as matting materials. A particularly useful attribute of acceptable materials is a capability of absorbing, instead of repelling, asphalts and other bituminous materials. Thus mats according to the invention may preferably be saturated with asphalts, etc., and not merely coated with them, as is the case with many synthetic materials, such as polyester.

Reinforcing fibers 102 may comprise fiberglass, plastics, and any other natural or other natural and synthetic fibers having adequate strength, durability, and resistance to bending or to breaking down in oil and petroleum-based products to serve the purposes described herein. The fibers are preferably between about 0.01 inch and about 0.5 inch long, most preferably in the range from about 0.01 to about 0.03 inch, and have diameters of about the same or smaller size, and are preferably more or less uniformly distributed throughout the matting material. A random fiber orientation is generally preferred, as it provides increased strength and wrinkling resistance in all directions throughout the mat. Fiberglass is generally preferred due to its strength and relatively low cost, especially when derived from used or recycled materials, but any of a wide variety of fibers will serve, including a great many polymers. Chopped fiber glass strands have been found to serve very well. In particular, it has been found that the relatively short length of the reinforcing fibers eases production of the mats, by among other things allowing usage of non-specialized machinery of the type already commonly used for the production of organic mats.

One of the most important uses of mats according to this aspect of the invention is in sheets and mats used in roofing and other water resistant membranes. It is therefore generally preferred that mats according to the invention have dimensions compatible with standard or conventional roofing and waterproofing techniques. Thus generally preferred embodiments of mats according to this aspect of the invention have widths of between about 24 inches and about 240 inches, and thicknesses of between about 15 mils and about 50 mils. Most commonly, mats are made in widths of integer multiples of standard roofing mat widths, and cut during or after placement onto shipping rolls to standard widths, which are most commonly between about 24 and about 48 inches. Due to the nature of the materials used in making the mats, and to the limitations of manual manipulation of finished rolls, as well as conventional expectations within the roofing and waterproofing industries, finished mats according to this aspect of the invention have weights of between about 0.02 pounds per square foot and about 0.10 pounds per square foot.

It is believed that reinforcing fibers 102 improve the tensile strength and wrinkle-resistant qualities of the sheet by adherence to the matting material. Due to the relatively greater strength of the adhered fibers, in comparison to the matting material, tensile and bending (i.e., wrinkling) loads induced in a fiber-reinforced mat are carried in disproportionate measure by the fibers, so that the matting material is protected from tearing or bending failure or wrinkling. The mechanics of fiber-reinforcement in carrying loads are well understood in some select fields, including notably structural engineering and the making and use of carbon-fiber composite materials for aircraft and other light-weight structures, but the possibilities of its use in roofing and waterproofing membranes has hitherto not been recognized, and no means or method for using or producing appropriate materials has heretofore appeared.

It has been found that a minimum ratio of about 1%, by weight, of reinforcing fibers to matting material is preferred to give satisfactory results for the purposes outlined herein. However, with some matting material—reinforcing fiber combinations ratios of considerably more or less than 1% may give satisfactory results. In general, a ratio of between about 1% and about 20% by weight of reinforcing fibers is preferred. In some applications a ratio greater than 20% is desired, but it has been found that ratios greater than that can in some circumstances tend to cause pluggage and malfunctions during the mat-making process. For use with otherwise conventional mat-making equipment, a ratio of about 5% to about 10% is preferred.

It has been found that fiber-reinforced mats according to the invention retain very good capabilities for the absorption of hydrocarbons, which permits excellent saturation of the mats with asphalt and the like, as for example in roofing or waterproofing applications. Mats according to the invention have been found to retain the ability to absorb between about 100 and about 120 percent of their own dry weight in kerosene, and to meet without difficulty the 120% minimum asphalt saturation values of ASTM D226.

The tensile strength of fiber-reinforced mats according to the invention has been found to increase greatly in comparison with no-reinforced organic mats, with tensile strengths being increased by 40% to 80% or more. For fiber-reinforced mats of the type described herein, test strengths of 80 pounds per inch or more in the machine direction and 20 pounds per inch or more in the cross-machine direction have been observed.

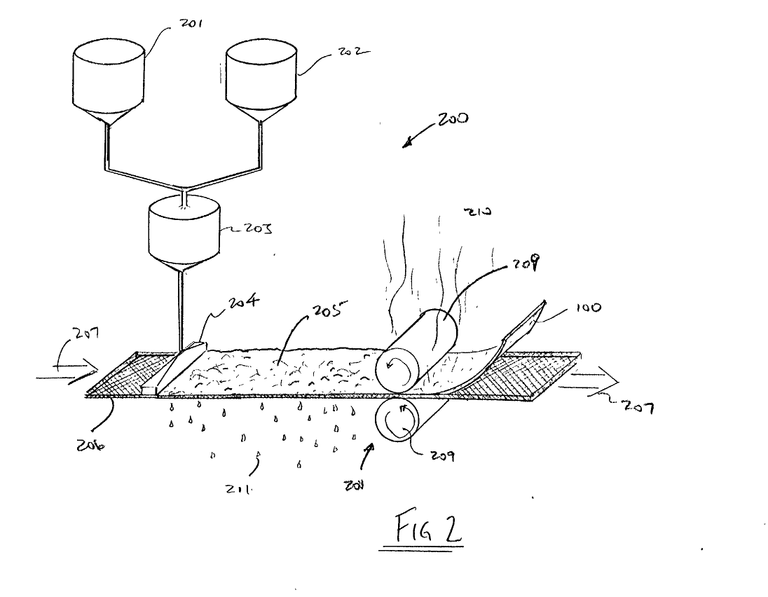

FIG. 2 is a schematic view of a preferred embodiment of a process for making a mat according to the invention. Mat-making apparatus 200 comprises matting material source 201, reinforcing fiber source 202, vat or tank 203 for mixing pulp, applicator 204, mold 206, and pressure and heat source 208. Pulp mixing tank 203 typically comprises means for selectively receiving matting material and reinforcing fibers from their respective sources; some means for selectively adding water to the matting material; a means for reducing the matting material to pulp, as for example a blade set or a set of hammers; and a means for blending the reinforcing fibers into the pulp. Pulp mixers of the type contemplated are well known within the pulp making industry.

Applicator 204 serves to introduce pulp 205 to mold 206. Although it may take a great many suitable forms, which will occur to those of normal skill in the art of pulp or mat-making, mold 206 is shown in the form of a screen. A screen mold offers, among other advantages, excellent drainage for the pulp, as water or other liquid by-products are allowed to drain freely from the pulp. As an optional step after pulp 205 is distributed satisfactorily through the mold (a satisfactory distribution is any distribution which will accommodate the purposes herein described), a combination of heat and pressure are applied to the molded pulp in order to compress and/or dry the matting material. In the apparatus shown, a combination of heat and pressure are applied to the mold by means of heated rollers 209, between which mold 206, with pulp 205, are moved in the direction of arrows 207. Drying and pressing of pulp 205 in the mold results in formation of two-sided, fiber-reinforced mat 100, which is ready for use in the other processes described herein. Most preferably, mat 100 is fed to a roll for convenient transportation, sale, and use.

The mat-making machinery shown herein is shown in functional form only. A great many apparatus combinations will serve; many satisfactory combinations are well known in the mat-making industry. In general, any mat-making apparatus will serve, so long as it is ensured that the addition of excessive proportions of reinforcing fibers to the apparatus will not cause pluggage or clogging. The handling and blending of the materials described and involved in making mats according to the invention will not trouble the mat-maker of ordinary skill, once he or she has been armed with this disclosure.

Thus the apparatus shown in FIG. 2 is suited for use in a method of producing a mat for use in waterproofing membranes, the mat exhibiting superior tensile strength and resistance to wrinkling, which comprises the steps of preparing a more or less or substantially uniform pulp of material selected from the group comprising cellulose, paper, other wood products felt, and other organic matting materials, fibers selected from the group comprising fiberglass, plastics, and other natural and synthetic fibers, and water, the combination comprising at least about 1% by dry weight of fibers; introducing the pulp onto a mold; and drying the pulp, with the optional addition of heat and/or pressure.

As stated, it is preferred that mats according to the invention comprise between about 1% and about 20% by weight of reinforcing fibers. It is also advantageous, depending upon the fiber materials used, to provide the mats with more than 20% fiber content, even upwards of 50-75%. It has been found, however, that most of the benefits of fiber-reinforcement may be realized in a most economical fashion by restricting the fiber content to about 20% or so, or most particularly to levels such as 5% to 10%, and making the mats with conventional mat-making apparatus, as fiber contents in excess of 20% have been observed to plug some conventional machinery.

It is well within the ability of those skilled in the relevant arts to produce mats having widths between about 24 inches and about 240 inches, and to trim those into rolls having standard roofing or waterproofing widths. It is likewise well within their skill to produce mats having a thickness of 15 mils and about 50 mils, and weights of between about 0.02 pounds per square foot and about 0.10 pounds per square foot. With respect to weights, it is noted that many of the types of fibers suitable for use as reinforcing fibers as contemplated by this disclosure are of significantly lower specific weights that the types of matting materials discussed; thus increasing the relative proportion of reinforcing fibers can have the effect of reducing the weight of the final mat.

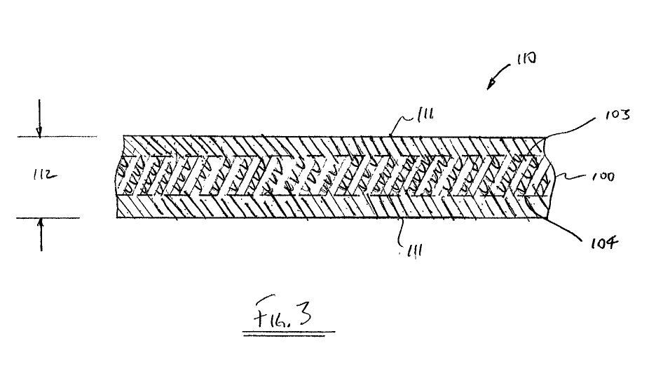

FIG. 3 is a sectional schematic view of a preferred embodiment of an asphalt coated fiber reinforced sheet according to the invention. Asphalt coated sheet 110 comprises fiber-reinforced mat 100 according to the invention, as herein described, and asphalt coating 111. In the embodiment shown asphalt coating 111 has been applied to both sides 103 and 104 of the mat; it is both convenient, economical, and otherwise advantageous in some situations to coat only one side of the mat. For example, it is often economical to coat only one side of the mat when a sprayer is used in the coating apparatus, as a second spraying device is not needed.

It is an important advantage of asphalt-coated sheets according to this aspect of the invention that the use of many of the matting materials described permits penetration or absorbence by the asphalt of the surface of the mat, such that all or some portion of the mat is saturated with asphalt. In particular, the use of cellulose or paper as matting material permits substantial penetration of the mat, resulting in improved resistance by the coated sheet to penetration by moisture. This penetration is illustrated by the use of broken lines at surfaces 103 and 104 of mat 100 in FIG. 3.

Preferred embodiments of the asphalt-coated sheet aspect of the invention are coated with asphalt to the extent that the coated sheet has a thickness 112 of between about 15 mils and about 60 mils after application of the asphalt. This facilitates use of the sheets in standard roofing and water proofing processes, and manipulation of standard-sized rolls of the sheet without machinery. When mats having weights in the ranges specified above are used, a coated sheet having a weight of between about 0.06 pounds per square foot and about 0.30 pounds per square foot after application of the asphalt results. It has been found that such weights are quite satisfactory.

Generally preferred asphalt for use with this aspect of the invention comprise asphalts having softening points of between about 50 degrees F. and about 225 degrees F. with penetration at 77 degrees F. of about 12 to about 100 1/10 millimeters. In particular, it is preferred to use SEBS or other rubber or polymer-modified asphalts having from about 1% to about 25% copolymer, and viscosities in the range of about 50 to about 350 centipoise at 400° F. In addition, up to 50% by weight of mineral fillers such as calcium carbonate may be added. Processes for making SEBS modified asphalts for use with process aspects of the invention are further described in my patent application Ser. No. 08/978,243, entitled “Styrene Ethylene Butylene Styrene (SEBS) Copolymer Rubber Modified Asphalt Mixture”; and Ser. No. 08/978,244, entitled “Plasticized Styrene Ethylene Butylene Styrene (SEBS) Copolymer Rubber Modified Asphalt Mixture”, the specifications of which have been incorporated in this specification. SEBS or other polymer-modified asphalts may be used in the processes and apparatus of this invention in the same manner as other asphalts, without special equipment or modifications.

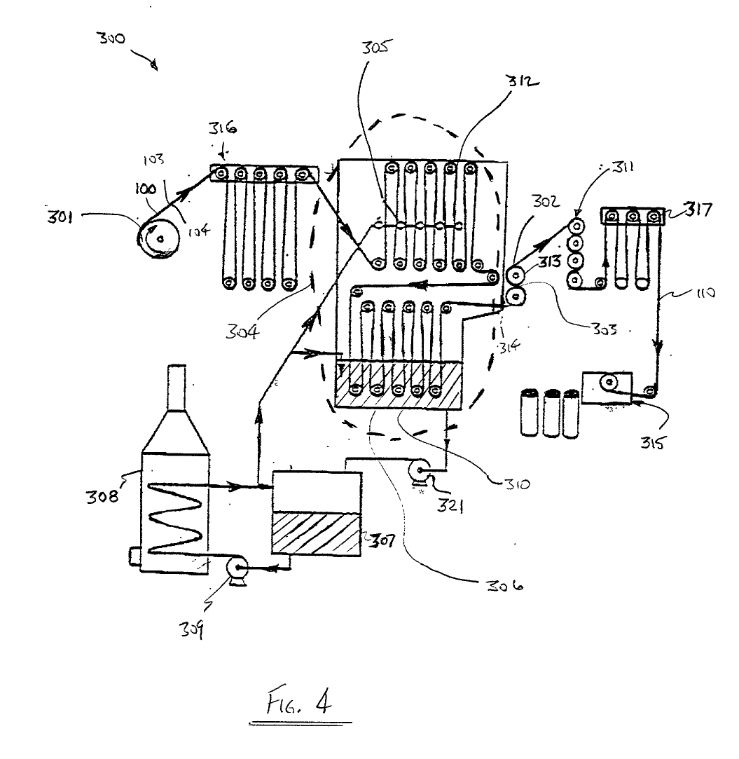

FIG. 4 is a schematic view of a preferred embodiment of a process for making an asphalt coated fiber reinforced sheet according to the invention. Sheet coating apparatus or roofing line 300 comprises feed roll 301, saturant supply 307 which comprises saturant heater 308, coating or saturating section 304, feed mechanism 302 which comprises nips 303, and optional roll winder 315. Optional dry looper 316, pumps 309 and 321, and cooling drums 311 are also shown. Feed mechanism 302 is shown in the form of drums 313 and 314 which by rotating while bearing upon mat 100 pull the mat through the coating section.

Mat 100 is wound onto feed roll 301, and a free end of the mat is fed through floating dry looper section 316, which allows the mat to be manipulated while the line is operating, and into coating or saturating section 304. The apparatus is depicted in the Figure in an optional embodiment comprising both a saturant spray section 312 and a saturant dip section or tank 310. Both sprayers and dip tanks are well known to those familiar with the arts of coating or saturating roofing or waterproofing mats and making roofing lines; and it is a further advantage of the invention that either or both will work in the processes herein described as they would for coating any other mats, without need for special modifications. As mat 100 passes through coating section 304 asphalt or other saturant from saturant storage 307, preferably after having been heated by heater 308 as described herein, is applied to either one or both sides of the mat. From coating section 304 mat 100, which may now be referred to also as sheet 110, passes through feed mechanism 302, a series of optional cooling and drying drums 311 and 317, and onto optional roll winder 315, which places the sheet in rolls suitable for easy handling in roofing and waterproofing processes. In the embodiment shown, excess saturant is recycled from coating section 304 through saturant storage 307 by means of recirculation pump 321, while primary transfer pump 309 transfers saturant from storage through heater 308 to the coating section.

As in conventional mat-coating processes, it is generally desirable in producing asphalt coated fiber-reinforced sheets according to the invention to heat the asphalt prior to applying it to the mat. Heating the asphalt or other saturant increases the penetration of the asphalt within the matting material and improves control of the quality and evenness of the asphalt coating. It also facilitates handling and application of the asphalt using the types of equipment described herein, without building up in or clogging the machinery. Thus coating mechanism or roofing line 300 is provided with optional saturant heater 308. Pump 309 removes asphalt from storage tank 307, passes it through heater 308, and pushes it into the coating or saturating section. In preferred processes according to the invention, the asphalt is heated to above its softening point, preferably in the range of 200° F. or more.

### EXAMPLE

An asphalt coated fiber reinforced sheet according to the invention is made on a coating line of the type depicted in FIG. 4. A cellulose mat impregnated with between 5% and 10% by weight fiberglass fibers of approximately 0.025 inches' average length is fed from a feed roll into the apparatus shown. The mat is approximately 40″ wide and between 25 and 30 mils thick, and weighs approximately 27 pounds per industry-standard roofing square of 480 square feet prior to coating. It is pulled through the line at approximately 400 feet per minute, and coated in a dual coating section of the type depicted with an SEBS modified, fully oxidized asphalt having a softening point of approximately 135° F. asphalt at approximately 440° F., using a double bank of spray bars (typically a bank of 14 total bars is available, with 8-10 in use at any one time) and a tank comprising 3 dip gates of the type shown in the Figure. The sheet produced is between about 30 and about 35 mils thick and weighs about 60 pounds per square. Thus a saturation level of approximately 120% is achieved. The finished sheet is cooled and wound onto rolls of approximately 100 feet lengths.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

### INDUSTRIAL APPLICABILITY

The invention has applicability in the roofing and waterproofing fields. In particular, it represents improvements in asphalt coated roofing and water resistant sheets, the sheets exhibiting superior tensile strength and wrinkling resistance, and therefore dramatically increased service life.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A mat for use in water resistant membranes, the mat exhibiting superior tensile strength and resistance to wrinkling, the mat comprised of:
an organic matting material; and
reinforcing fibers dispersed within the organic matting material.

2. The mat of claim 1, the mat comprising between about 1% and about 20% by weight of reinforcing fibers.

3. The mat of claim 1, having a width of between about 24 inches and about 240 inches.

4. The mat of claim 1, having a thickness of between about 15 mils and about 50 mils.

5. The mat of claim 1, having a weight of between about 0.02 pounds per square foot and about 0.10 pounds per square foot.

6. An asphalt coated fiber reinforced sheet for use in water resistant membranes, the sheet comprising:
a mat having two sides and comprised of an organic matting material;
reinforcing fibers dispersed within the organic matting material; and
an asphalt coating applied to at least one of said sides.

7. The sheet of claim 6, the sheet comprising between about 1% and about 20% by weight reinforcing fibers before application of the asphalt.

8. The sheet of claim 6, having a width of between about 24 inches and about 240 inches.

9. The sheet of claim 6, having a thickness of between about 15 mils and about 60 mils after application of the asphalt.

10. The sheet of claim 6, having a weight of between about 0.06 pounds per square foot and about 0.30 pounds per square foot after application of the asphalt.

11. A method of producing a mat for use in water resistant membranes, the mat exhibiting superior tensile strength and resistance to wrinkling, the method comprising the steps of:
preparing a pulp of organic matting material, reinforcing fibers, and water;
introducing the pulp to a mold to form a mat; and
drying the pulp.

12. The method of claim 11, comprising the step of subjecting the molded pulp to heat in drying it.

13. The method of claim 1, comprising the step of subjecting the molded pulp to pressure in forming it.

14. The method of claim 11, further comprising the step of winding the dried mat onto a roll.

15. The method of claim 11, the finished mat comprising between about 1% and about 20% by weight of reinforcing fibers.

16. The method of claim 11, having a width of between about 24 inches and about 240 inches.

17. The method of claim 11, having a thickness of between about 15 mils and about 50 mils.

18. The method of claim 11, having a weight of between about 0.02 pounds per square foot and about 0.10 pounds per square foot.

19. A method of producing an asphalt coated fiber reinforced roofing sheet exhibiting superior tensile strength and resistance to wrinkling, the method comprising the steps of:
placing a fiber reinforced mat on a feed roll, the mat having two sides and a free end and comprised of an organic matting and having reinforcing fibers dispersed within the organic matting material;
feeding said free end of said mat to a feed mechanism;
passing said sheet through a coating section disposed between said feed mechanism and said feed roll; and
coating at least one of said sides with asphalt as it passes through said coating section.

20. The method of claim 19, wherein the mat is coated with asphalt to the extent that after application of the asphalt the sheet has a thickness of between about 15 mils and about 60 mils.

21. The method of claim 19, wherein the mat is coated with asphalt to the extent that after application of the asphalt the sheet has a weight of between about 0.06 pounds per square foot and about 0.30 pounds per square foot.

22. The mat of claim 1, wherein said organic matting material is selected from the group consisting of cellulose, paper, wood products, and felt.

23. The mat of claim 1, wherein said reinforcing fibers are comprised of material selected from the group consisting of fiberglass, plastics, and other polymers and synthetic fibers.

24. The sheet of claim 6, wherein said organic matting material is selected from the group consisting of cellulose, paper, wood products, and felt.

25. The sheet of claim 6, wherein said reinforcing fibers are comprised of material selected from the group consisting of fiberglass, plastics, and other polymers and synthetic fibers.

26. The method of claim 11, wherein said organic matting material is selected from the group consisting of cellulose, paper, wood products, and felt.

27. The method of claim 11, wherein said reinforcing fibers are comprised of material selected from the group consisting of fiberglass, plastics, and other polymers and synthetic fibers.

28. The method of claim 19, wherein said organic matting material is selected from the group consisting of cellulose, paper, wood products, and felt.

29. The method of claim 19, wherein said reinforcing fibers are comprised of material selected from the group consisting of fiberglass, plastics, and other polymers and synthetic fibers.
